(19) United States
(12) Patent Application Publication
(10) Pub. No.: US 2024/0418031 A1
(43) Pub. Date: Dec. 19, 2024

(54) FENESTRATION UNIT SEALING SYSTEMS WITH WATER FUNNELING DUST PLUGS AND METHODS

(71) Applicant: ANDERSEN CORPORATION, Bayport, MN (US)

(72) Inventors: Paul Morris, Roseville, MN (US); Todd Bruchu, Lake Elmo, MN (US); Justin Depew, Stillwater, MN (US)

(21) Appl. No.: 18/676,824

(22) Filed: May 29, 2024

Related U.S. Application Data
(60) Provisional application No. 63/472,682, filed on Jun. 13, 2023.

(51) Int. Cl. E06B 7/14; E06B 7/205

(52) U.S. Cl. CPC E06B 7/14; E06B 7/205

(57) ABSTRACT

Water funneling dust plugs, fenestration units including the dust plugs, and related methods are described herein. The sealing systems of fenestration units described herein include features to improve scaling the transition between cantilevered weatherstrips on a side frame member and sill/bottom weatherstripping which is notorious for allowing air and/or water to pass.

### RELATED APPLICATION

The present application claims the benefit under 35 U.S.C. § 119 (e) of U.S. Provisional Patent Application 63/472,682 filed on Jun. 13, 2023, which is hereby incorporated by reference in its entirety.

Water funneling dust plugs, fenestration units including the dust plugs in sealing systems, and related methods are described herein.

Dust plugs are used to transition the weather seal in fenestration units between, for example, cantilevered (typically foam) weatherstrips and sill/bottom weatherstrips. The cantilevered weatherstrip is typically oriented vertically on a side jamb while the sill/bottom weatherstrips are typically oriented horizontally, e.g., at the bottom of a moving panel. As a result, the seals formed between the moving panel by the two weatherstrips are located in different planes. While often used in hinged doors, dust plugs may also be used in other fenestration products to maintain a weather seal in tough to seal transitions (e.g., check rails, intermediate jambs, meeting stiles, weatherstrip ends, etc.).

### SUMMARY

Water funneling dust plugs, fenestration units including the dust plugs in sealing systems, and related methods are described herein.

In one or more embodiments, the sealing systems of fenestration units described herein include features to improve sealing the transition between cantilevered weatherstrips on a side frame member (such as, e.g., a jamb, astragal, meeting rail, check rail, mull post (e.g., integral mull post), interlock (of a gliding patio door), etc.) and sill/bottom weatherstripping which is notorious for allowing air and/or water to pass. In one or more embodiments, the sealing systems with dust plugs as described herein may provide enhanced performance that may be particularly beneficial for fenestration units exposed to extreme weather events such as, e.g., tropical storms, hurricanes, cyclones, tornados, derechos, thunderstorms, rainstorms, etc. in which larger volumes of water and/or high winds are directed onto the fenestration units described herein.

In one or more embodiments, the dust plugs in sealing systems as described herein include a support member positioned in a channel formed by the cantilevered leg of the vertical/side frame member weatherstrip. In the absence of the support member, the cantilevered leg of the weatherstrip is easier to deflect/compress because, e.g., it is unsupported at its end. As a result, the end portion of the cantilevered leg may form a less robust seal with the face of the moving panel. The support member of one or more embodiments of the dust plugs described herein, however, provides additional resistance to deflection of the cantilevered leg at this critical interface to improve the seal formed between the face of the panel and the cantilevered leg.

The support members of one or more embodiments of the dust plugs of the sealing systems described herein may also address another potential issue sometimes referred to as “weatherstrip tucking” when a secondary seal is provided between the panel edge and the side frame member (such as, e.g., a jamb, astragal, meeting rail, check rail, mull post (e.g., integral mull post), interlock (of a gliding patio door), etc.) (the panel edge being the edge of the panel facing the side jamb when the panel is in a closed configuration in the frame of the fenestration unit). Such secondary seals may, if located close enough to the exterior face of the panel, catch the cantilevered leg of the weatherstrip and prevent the cantilevered leg from returning to its fully unconstrained configuration (e.g., its full reach). Weatherstrip tucking can reduce the effectiveness of the seal at the end of the door panel and may, over time, result in a permanent set in the cantilevered leg of the vertical/side member weatherstrip. The support member of one or more embodiments of the dust plugs described herein, however, can assist in returning the cantilevered leg to its fully unconstrained configuration (e.g., its full reach) to improve the seal formed between the face of the panel and the cantilevered leg.

One or more embodiments of the sealing systems including dust plugs as described herein provide features configured to funnel water that passes through the seal formed between the panel face and the cantilevered leg of the vertical/side frame member weatherstrip to the top of the sill and direct incoming water back to the exterior of the fenestration unit. For example, commercially available entry doors typically do not need to manage or expel significant amounts of infiltrating water because they carry no or low “Performance Grade (PG)” water ratings.

Fenestration units (including, but not limited to entry doors) incorporating the sealing systems described herein in combination with a contain and drain sill may, however, offer the opportunity to achieve PG30 or even PG50 water performance ratings.

Among the features of one or more embodiments of the dust plugs of the sealing systems described herein that contribute to water management is the interior weatherstrip member. That feature prevents passage of water towards the interior of the fenestration unit at the corner junction between the bottom of the panel and the vertical/side jamb. Where present, the intermediate weatherstrip member found in one or more embodiments of the dust plugs may assist in funneling water on the vertical/side frame member to the sill.

Another advantage of one or more embodiments of the sealing systems using one or more embodiments of the dust plugs described herein is in resistance of the dust plugs to damage from movement of the panels within the fenestration units. In particular, one or more embodiments of the sealing systems include a cavity in the side frame member into which at least the leading edge of the base of a dust plug is positioned such that a panel moving over the leading edge of the dust plug base does not contact that leading edge which could potentially dislodge the dust plug. Such cavities (and dust plugs having leading edges sized to fit within them) are particularly useful in fenestration units having rotating panels such as, e.g., entry doors, etc.

In a first aspect, one or more embodiments of a sealing system for a fenestration unit as described herein include: a fenestration frame comprising a side frame member connected to a sill, wherein the sill and the side frame member comprise an interior side and an exterior side, and wherein the side frame member extends along a side frame member axis extending away from the sill; a panel retained in the fenestration frame, the panel positioned above the sill, the panel comprising an interior face, an exterior face, a first edge, a second edge, a top edge, and a bottom edge, wherein, when the panel is in a closed configuration in the fenestration frame, the first edge faces the side frame member and the bottom edge faces the sill; a side frame member weatherstrip attached to the side frame member, wherein, when the panel is in a closed configuration in the fenestration frame, the first edge of the panel faces the side frame member, the bottom edge of the panel faces the sill, and the exterior face of the panel contacts the side frame member weatherstrip, wherein the side frame member weatherstrip comprises a cantilevered leg that, when the exterior face of the panel is not in contact with the side frame member weatherstrip, defines a channel aligned with the side frame member axis, the first channel located between the side frame member and the cantilevered leg, and wherein, when the panel is in the closed configuration, the exterior face of the panel displaces the cantilevered leg towards the side frame member to reduce a size of the channel. The sealing systems also include a dust plug comprising: a base attached to the side frame member proximate the sill; a support member attached to the base, the support member located in the channel between the side frame member and the cantilevered leg proximate the sill; an exterior weatherstrip member attached to the base, wherein a portion of the exterior weatherstrip member is located in a panel-sill gap measured along the side frame member axis between the bottom edge of the panel and a top of the sill at a junction between the bottom edge, the exterior face, and the first edge of the panel when the panel is in the closed configuration; and an interior weatherstrip member attached to the base, the interior weatherstrip member located proximate an interior edge of the base such that the exterior weatherstrip member is located between the support member and the interior weatherstrip member, and wherein the interior weatherstrip member contacts the first edge of the panel when the panel is in the closed configuration.

In one or more embodiments of the sealing systems described herein, the exterior weatherstrip member is located in the channel between the support member and the cantilevered leg when the exterior face of the panel is not in the closed configuration such that the panel is not in contact with the cantilevered leg of the side frame member weatherstrip.

In one or more embodiments of the sealing systems described herein, the sealing system comprises a sweep attached to the bottom edge of the panel such that, when the panel is in the closed configuration, the sweep is located in the panel-sill gap, wherein the sweep extends between a first end proximate the first edge of the panel and a second end proximate the second edge of the panel, and wherein the portion of the exterior weatherstrip member located in the panel-sill gap contacts the first end of the sweep when the panel is in the closed configuration.

In one or more embodiments of the sealing systems described herein, the exterior weatherstrip member is aligned with the side frame member axis.

In one or more embodiments of the sealing systems described herein, the interior weatherstrip member is aligned with the side frame member axis.

In one or more embodiments of the sealing systems described herein, the support member comprises a support member height measured along the side frame member axis, and wherein the support member height is greater than the panel-sill gap.

In one or more embodiments of the sealing systems described herein, the dust plug comprises a drain channel aligned with the side frame member axis, the drain channel located between the support member and the interior weatherstrip member such that drain channel is located between the first edge of the panel and the side frame member when the panel is in the closed configuration. In one or more embodiments, the drain channel is located between the exterior weatherstrip member and the interior weatherstrip member.

In one or more embodiments of the sealing systems described herein, the exterior weatherstrip member comprises an exterior weatherstrip member height measured along the side frame member axis, and wherein the exterior weatherstrip member height is greater than the panel-sill gap. In one or more embodiments, the support member height is equal to the exterior weatherstrip member height.

In one or more embodiments of the sealing systems described herein, the interior weatherstrip member comprises an interior weatherstrip member height measured along the side frame member axis, and wherein the interior weatherstrip member height is greater than the panel-sill gap.

In one or more embodiments of the sealing systems described herein, the base comprises an interior edge facing away from the side frame member weatherstrip and the side frame member comprises a cavity, wherein the interior edge of the base is recessed within the cavity such that the interior edge is obscured by the side frame member when viewed along an interior-exterior axis extending between the interior side and the exterior side of the side frame member. In one or more embodiments, the cavity comprises a cavity depth measured in a direction transverse to the interior-exterior axis, and wherein the cavity depth decreases when moving along the base from the interior edge towards the side frame member weatherstrip.

In one or more embodiments of the sealing systems described herein, the base of the dust plug is adhesively attached to the side frame member.

In one or more embodiments of the sealing systems described herein, the dust plug comprises an intermediate weatherstrip member attached to the base, the intermediate weatherstrip member located between the exterior weatherstrip member and the interior weatherstrip member, and wherein the intermediate weatherstrip member contacts the first edge of the panel when the panel is in the closed configuration.

In one or more embodiments of the sealing systems including a dust plug having an intermediate weatherstrip member as described herein, the intermediate weatherstrip member is aligned with the side frame member axis.

In one or more embodiments of the sealing systems including a dust plug having an intermediate weatherstrip member as described herein, the intermediate weatherstrip member comprises an intermediate weatherstrip member height measured along the side frame member axis, and wherein the intermediate weatherstrip member height is greater than the panel-sill gap. In one or more embodiments, the intermediate weatherstrip member height is equal to or greater than the interior weatherstrip member height.

In one or more embodiments of the sealing systems including a dust plug having an intermediate weatherstrip member as described herein, dust plug comprises a drain channel aligned with the side frame member axis, the drain channel located between the intermediate weatherstrip member and the interior weatherstrip member such that drain channel is located between the first edge of the panel and the side frame member when the panel is in the closed configuration.

In one or more embodiments of the sealing systems including a dust plug having an intermediate weatherstrip member as described herein, a first distance, as measured along an interior-exterior axis extending between the interior side and the exterior side of the side frame member, between the intermediate weatherstrip member and the exterior face of the panel is less than a second distance between interior weatherstrip member and the interior face of the panel.

In a second aspect, methods of sealing an interface between a panel and a side frame member of a fenestration unit as described herein include: positioning a dust plug on a side frame member of a fenestration panel, wherein the dust plug comprises a base attached to the side frame member proximate a sill of the fenestration unit, a support member attached to the base, and an exterior weatherstrip member attached to the base, wherein a portion of the exterior weatherstrip member is located in a panel-sill gap measured along the side frame member axis between a bottom edge of the panel and a top of a sill of the fenestration unit at a junction between a bottom edge of the panel, an exterior face of the panel, and a first edge of the panel when the panel is in a closed configuration in which the first edge of the panel displaces the cantilevered leg of the side frame weatherstrip member towards the side frame member, and an interior weatherstrip member attached to the base, the interior weatherstrip member located proximate an interior edge of the base such that the exterior weatherstrip member is located between the support member and the interior weatherstrip member, and wherein the interior weatherstrip member contacts the first edge of the panel when the panel is in the closed configuration. Positioning the dust plug on the side frame member comprises locating the support member of the dust plug between the side frame member and a cantilevered leg of a side frame weatherstrip member attached to the side frame member, wherein the support member forces the cantilevered leg away from the side frame member proximate the sill when the panel is not in the closed configuration.

In one or more embodiments of the methods of sealing an interface between a panel and a side frame member of a fenestration unit as described herein, the dust plug directs water passing along the side frame member towards the sill through a drain channel aligned with a side frame member axis of the side frame member when the panel is in the closed configuration, the drain channel located between the interior weatherstrip member and the support member.

In one or more embodiments of the methods of sealing an interface between a panel and a side frame member of a fenestration unit as described herein, the dust plug comprises an intermediate weatherstrip member attached to the base, the intermediate weatherstrip member located between the exterior weatherstrip member and the interior weatherstrip member, and wherein the intermediate weatherstrip member contacts the first edge of the panel when the panel is in the closed configuration.

Where used herein, the terms “exterior” and “interior” are used in a relative sense, for example, an exterior surface and an interior surface may be used to describe surfaces located on opposite sides of a fenestration unit. In actual use, and exterior surface could be found within the interior of a building or other structure where the surface would conventionally be defined as an interior surface, while an interior surface could be found outside of a building or other structure where the surface would conventionally be defined as an exterior surface.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein.

The above summary is not intended to describe each embodiment or every implementation of the contain and drain sill systems, fenestration units incorporating them, and related methods as described herein. Rather, a more complete understanding of the invention will become apparent and appreciated by reference to the following Description of Illustrative Embodiments and claims in view of the accompanying figures of the drawing.

### BRIEF DESCRIPTION OF THE VIEWS OF THE DRAWING

Each of the figures described herein include axes corresponding to a three-dimensional Cartesian coordinate system to facilitate an understanding of the illustrative embodiments of the invention depicted in the figures and described herein.

FIG. 1 depicts one illustrative embodiment of a fenestration unit in the form of a swinging/rotating door system as described herein.

FIG. 2 is a cross-sectional view of the fenestration unit taken along line 2-2 in FIG. 1 depicting the position of the cross-sectional view.

FIG. 3 is a partial cross-sectional perspective view of the junction between the sill and a side frame member of the fenestration unit depicted in FIG. 1 with the panel removed to expose components the dust plug.

FIG. 4 depicts the side jamb of FIG. 3 in a cross-sectional view taken in the X-Z plane above the dust plug and looking towards the sill with a panel in the closed configuration as described herein.

FIG. 5 is a front view of the dust plug depicted in FIGS. 3-4 (removed from the fenestration unit).

FIG. 6 is a top view of the dust plug depicted in FIG. 5.

FIG. 7 is a top left perspective view of the dust plug depicted in FIGS. 5 and 6.

FIG. 8 is a top right perspective view of the dust plug depicted in FIGS. 5 and 6.

FIG. 9 is an enlarged top view of a portion of the side frame member and sealing system components depicted in FIG. 4 with the panel removed.

FIG. 10 is a view of FIG. 9 with the dust plug removed.

FIG. 11 is an enlarged cross-sectional view of the junction between the sill, side frame member, door panel, sweep, side member weatherstrip, and dust plug of one illustrative embodiment of the sealing system for a fenestration unit as described herein taken along line 11-11 in FIG. 1.

FIG. 12 is a cross-sectional view of the junction depicted in FIG. 11 taken along line 12-12 in FIG. 11.

FIG. 13 depicts one alternative embodiment of a dust plug that could be used in one or more embodiments of the sealing systems described herein.

### DESCRIPTION OF ILLUSTRATIVE EMBODIMENTS

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

Although the illustrative embodiments depicted in the figures are focused on sealing systems in hinged doors, the sealing systems described herein may be used in connection with any fenestration unit (e.g., window, door, etc.) including a frame having a side frame member and sill (where it is understood that the sill is the frame component installed at the bottom or lowermost portion of the fenestration unit). Although the depicted fenestration units have a rotating panel, the fenestration units using the sealing systems described herein may include panels that move in transition, i.e., slide or glide within the fenestration unit frame. As installed, the fenestration units described herein have a frame that includes an exterior side and an interior side, where the exterior side typically (but not necessarily) faces the exterior of a building in which the fenestration units are installed and the interior side typically (but not necessarily) faces the interior of the building.

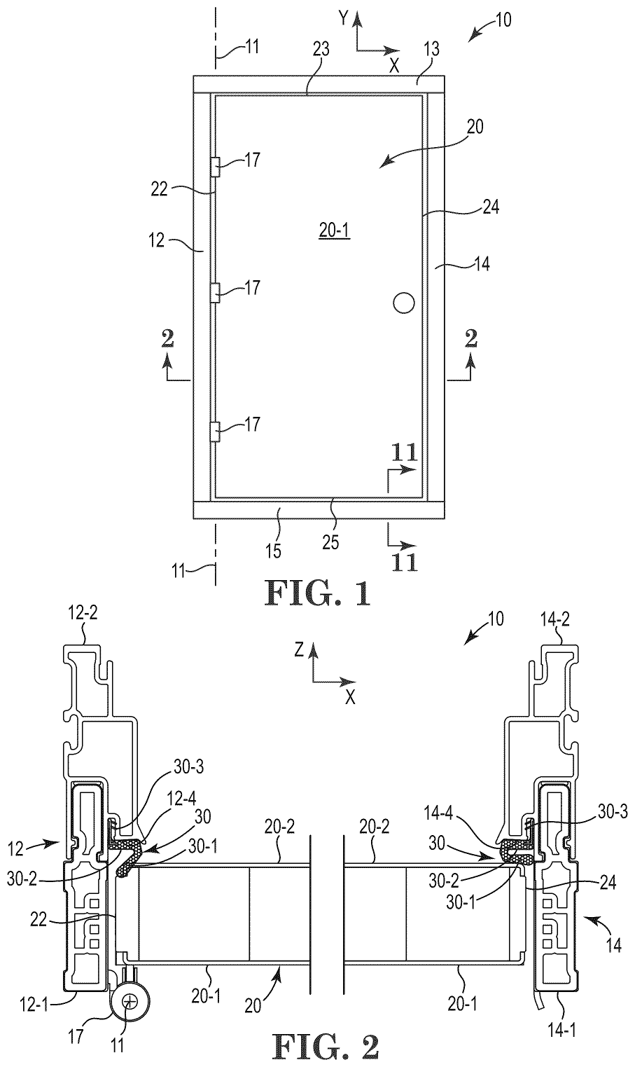

Various features of the sealing systems and/or fenestration units described herein are described using terms such as “below” and/or “above” and it should be understood that these terms are used to describe relative positions of the features in a fenestration unit as installed in a building with respect to the direction of gravity. FIG. 1 depicts one illustrative embodiment of a fenestration unit as described herein in the form of a hinged door system. The depicted fenestration unit 10 includes a frame having a hinge side frame member 12, a head frame member 13, a latch side frame member 14, and a sill 15. Door panel 20 is located between hinge side frame member 12 and latch side frame member 14 and is connected to hinge side frame member 12 by hinges 17. The door panel 20 is configured to rotate about a hinge axis 11 that is generally aligned with the hinge side frame member 12. The door panel 20 includes a hinge edge 22 facing the hinge side frame member 12 when the door panel 20 is in a closed configuration within the frame as depicted in FIG. 1. Door panel 20 also includes a latch edge 24 facing the latch side frame member 14, a top edge 23 facing the head frame member 13, and a bottom edge 25 facing the sill 15.

One or more of the frame members (and/or portions of frame members) of one or more embodiments of fenestration units described herein, e.g., the side frame members 12 and 14, head frame member 13, and sill 15 may be manufactured by a variety of processes. In one or more embodiments, however, one or more of the frame members (and/or portions of frame members) may be manufactured of an extruded material which may include fibers and a polymer, pultruded materials, metals, etc. Examples of some potentially suitable constructions for frame members that may be used to construct window frames as described herein may include those described in, e.g., U.S. Pat. No. 5,585,155 (Heikkila et al.); U.S. Pat. No. 6,106,944 (Heikkila et al.); U.S. Pat. No. 6,210,792 Seethamraju et al.); U.S. Pat. No. 6,260,251 (Guhl); U.S. Pat. No. 6,280,667 (Koenig et al.); U.S. Pat. No. 6,342,172 (Finley); etc. Frame members constructed in an extrusion or pultrusion process may include hollows or cavities formed along their length, with the walls and connecting structures of the frame members being formed of the extruded or pultruded material. In one or more embodiments, the hollows or cavities may be filled with one or more materials such as foam, etc. to, e.g., change the insulation characteristics and/or the structural rigidity of the frame members.

In the following descriptions of illustrative embodiments, the side frame members of the sealing systems of fenestration units described herein are described as side jambs for simplicity. The side frame members may take a variety of different forms depending on the fenestration units including the sealing systems although the side frame members are typically oriented vertically (or nearly vertically) when the fenestration units are installed. Fenestration units in which the sealing systems described herein may be used include, but are not limited to, entry doors, patio doors, windows, etc. The side frame members in the fenestration units may be in the form of, e.g., jambs, astragals, meeting rails, check rails, mull posts (e.g., integral mull posts), interlocks (of gliding patio doors), etc.

FIG. 2 is a cross-sectional view of the fenestration unit of FIG. 1 taken along line 2-2 in FIG. 1 with the head jamb and sill removed for clarity. As depicted in FIGS. 1-2, the door panel 20 is in a closed configuration in the fenestration unit frame such that the hinge edge 22 of the door panel 20 faces the hinge side jamb 12 and the latch edge 24 of the door panel 20 faces the latch side jamb 14. The panel 20 also includes a top edge 23 facing head jamb 13 and a bottom edge 25 facing the sill 15.

With reference to FIG. 2, the hinge side jamb 12 includes an interior side 12-1 and an exterior side 12-2 while latch side jamb 14 includes an interior side 14-1 and an exterior side 14-2. Panel 20 also includes an interior face 20-1 facing in the same direction as the interior sides 12-1 and 14-1 of the side jambs 12 and 14. Panel 20 further includes an exterior face 20-2 facing in the same direction as the exterior sides 12-2 and 14-2 of side jambs 12 and 14.

The interior-exterior sides and surfaces of the fenestration unit 10 can be described as defining an interior-exterior axis extending between the interior and exterior sides of the fenestration unit frame, e.g., between the interior sides 12-1/14-1 and exterior sides 12-2/14-2 of the side jambs 12/14. As depicted in FIG. 2, the interior-exterior axis is aligned with the Z-axis of the depicted Cartesian coordinate system.

Another feature depicted in connection with the illustrative embodiment of hinge side jamb 12 is a hinge side door stop 12-4 as well as a latch side door stop 14-4 depicted on latch side jamb 14.

Door stops 12-4 and 14-4, in addition to closing direct line of sight access through the gaps between the hinge side jamb 12 and hinge edge 22 and the latch side jamb 14 and latch edge 24, provide support for side member weatherstrips 30 positioned on each of the door stops. The weatherstrips 30 each include a cantilevered leg 30-1, a base 30-2 positioned on the respective door stop 12-4 or 14-4 and a retainer leg 30-3 positioned in a kerf or channel provided in the jamb between the door stop and the remainder of the jamb.

Weatherstrips 30 are conventionally made of resilient compressible materials designed to form a seal between the face of a door panel and the jamb. In particular, cantilevered legs 30-1 are typically deflected towards the door stops as the door panel 20 moves into its closed configuration. In the illustrative embodiment depicted in FIG. 2, the cantilevered leg 30-1 of the weatherstrip 30 attached to the jamb 14 is depicted as being displaced towards the jamb 14 by the panel 20 while the cantilevered leg 30-1 of the weatherstrip 30 attached to the hinge side jamb 12 is not deflected to depict the channel formed between base 30-2 and cantilevered leg 30-1 of the weatherstrip 30.

With reference to the hinge side of the fenestration unit is depicted in FIG. 2, it can be seen that when the exterior face 20-2 of the panel 20 is spaced apart from the weatherstrip 30 (i.e., the door panel 20 is not in the closed configuration), the cantilevered leg 30-1 extends away from the stop 12-4 and towards the side jamb 12 such that the cantilevered leg 30-1 defines a channel aligned with a jamb axis (e.g., the Y-axis) with the channel being located between the stop 12-4 and the cantilevered leg 30-1 (as well as the face of the side jamb 12). In contrast, when the panel 20 is in the closed configuration such that the cantilevered leg 30-1 of the weatherstrip 30 attached to the latch side jamb 14 is contacted by the face 20-2 of panel 20, the cantilevered leg 30-1 is displaced towards the stop 14-4 and the latch side jamb 14.

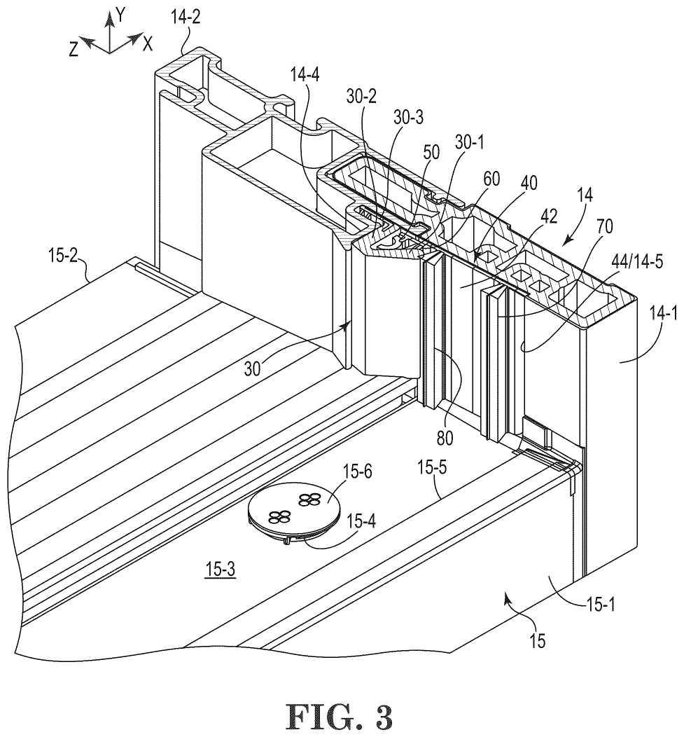

FIG. 3 depicts the junction between a side jamb 14 and sill 15 in the fenestration unit 10 with the panel removed. As depicted, the side jamb 14 includes an interior side 14-1 and exterior side 14-2 along with a side member weatherstrip 30 positioned on door stop 14-4. Also depicted in FIG. 3 are features of the depicted illustrative embodiment of sill 15 which includes an interior side 15-1 and an exterior side 15-2 along with a top surface 15-3. The top surface 15-3 of the sill 15 faces the bottom edge 25 of door panel 20 when the door panel 20 is in the closed configuration as described herein.

The depicted embodiment of sill 15 also includes water management features used to control water reaching the portion of the sill on the interior side of weatherstrip 30. The depicted sill 15 is in the form of a “contain and drain” type sill including interior chambers and exterior drains configured to move water to the exterior side 15-2 of the sill 15. Those features may include a drain 15-4 and drain cover 15-6 on the top surface 15-3 with water passing into the drain to reach interior chambers of the sill 15 where the water can be removed to the exterior side 15-2 of sill 15. Another water control feature found on sill 15 is a step 15-5 on the top surface 15-3 of the sill, with the step 15-5 providing a small but significant barrier to further movement of water towards the interior side 15-1 of sill 15 to promote drainage of that water through drain 15-4.

While contain and drain sills are known, one or more embodiments of the sealing systems for fenestration units as described herein include a water channeling dust plug 40 configured to limit and/or control the passage of water past the interface between a panel and the side jamb 14. The depicted illustrative embodiment of water channeling dust plug 40 includes a base 42 attached to the side jamb 14 proximate the sill 15, a support member 50 attached to the base 42, with the support member 50 being located in the channel between the stop 14-4 and the cantilevered leg 30-1 of side member weatherstrip 30, an exterior weatherstrip member 60 attached to the base 42, and an interior weatherstrip member 70 attached to the base 42. The depicted illustrative embodiment of dust plug 40 also includes an optional intermediate weatherstrip member 80 attached to the base 42.

The support member 50 attached to the base 42 of the dust plug 40 is positioned in the channel formed by the cantilevered leg 30-1 of the side member weatherstrip 30 to support the cantilevered leg 30-1 proximate the sill end of the side member weatherstrip 30. As discussed herein, the support member 50 provides additional resistance to deflection of the cantilevered leg 30-1 at that critical interface proximate the sill 15 to improve the seal formed between the panel 20 and the cantilevered leg 30-1 of side member weatherstrip 30.

The depicted illustrative embodiment of dust plug 40 also includes an exterior weatherstrip member 60 attached to the base 42. A portion of the exterior weatherstrip member 60 is located in the panel-sill gap located between the bottom edge 25 of panel 20 and the top 15-3 of the sill 15 (the panel-sill gap is measured along the side jamb axis extending along the Y-axis). In one or more embodiments, a portion of the of the exterior weatherstrip member 60 is also located above the bottom edge 25 of panel 20.

The depicted illustrative embodiment of dust plug 40 also includes an interior weatherstrip member 70 attached to the base 42. The interior weatherstrip member 70 is located proximate an interior edge 44 of the base 42. As a result, the exterior weatherstrip member 60 may be described as being located between the interior weatherstrip member 70 and the stop 14-4 of jamb 14. In one or more embodiments, the exterior weatherstrip member 60 may also be described as being located between the interior weatherstrip member 70 and the support member 50.

Also depicted in connection with the illustrative embodiment of dust plug 40 is an optional intermediate weatherstrip member 80 attached to the base 42. The intermediate weatherstrip member 80 is, in the depicted embodiment, located between the exterior weatherstrip member 60 and the interior weatherstrip member 70.

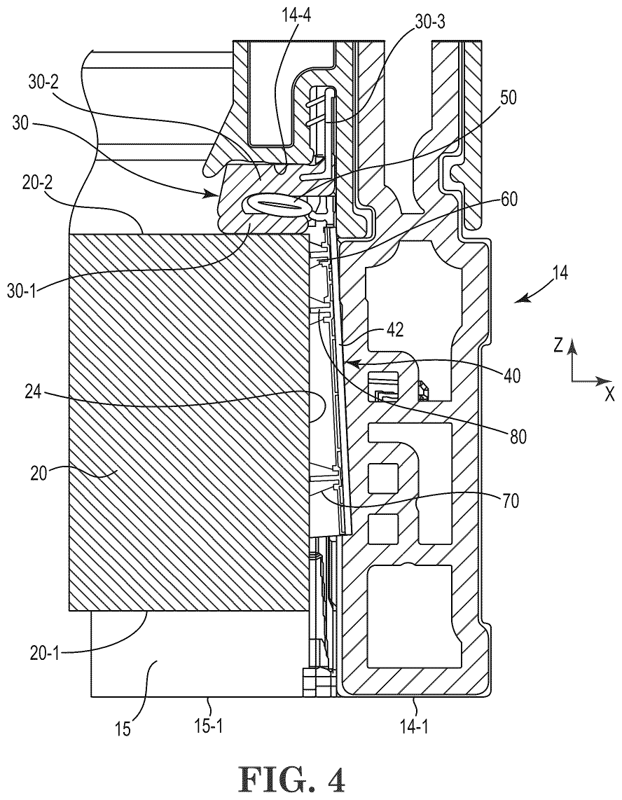

FIG. 4 depicts the side jamb 14 in a cross-sectional view taken in the X-Z plane above the dust plug and looking towards the sill 15 with a panel 20 in the closed configuration such that the latch edge 24 of the panel 20 faces the side jamb 14.

When panel 20 is in the closed configuration as depicted in FIG. 4, the face 20-2 of panel 20 contacts and moves the cantilevered leg 30-1 towards the stop 14-4 and also compresses the support member 50 between the base 30-2 and cantilevered leg 30-1. In the depicted configuration, the exterior weatherstrip member 60 contacts the latch edge 24 of panel 20 above the panel-sill gap. That contact between the exterior weatherstrip member 60 and the edge of panel 20 may provide additional sealing along the edge of the panel 20.

Also in that closed configuration, the interior weatherstrip member 70 contacts the latch edge 24 of panel 20. That contact between the interior weatherstrip member 70 and the edge 24 of panel 20 provides additional sealing along the edge of the panel 20.

When provided, the intermediate weatherstrip member 80 also contacts the latch edge 24 of panel 20 when the panel is in the closed configuration to provide even more sealing.

One or more embodiments of the dust plugs of sealing systems described herein may be characterized as providing a drain channel that may assist in funneling water that infiltrates the seal between the side member weatherstrip 30 and the door panel 20 and, under the force of gravity, travels towards the sill 15 to the top of the sill 15 before that water reaches the interior of the panel 20.

In particular, the junction between the sill, jamb, and panel can provide a pathway for air to pass through that junction from the exterior side of the fenestration unit towards the interior side. Water running along the jamb towards the sill proximate that junction can potentially be driven to the interior side of the fenestration unit. The drain channel (or channels) provided at that junction by the dust plugs of the sealing systems described herein can control any such water and prevent (or significantly limit) the likelihood that water will reach the interior side of the fenestration unit at that junction.

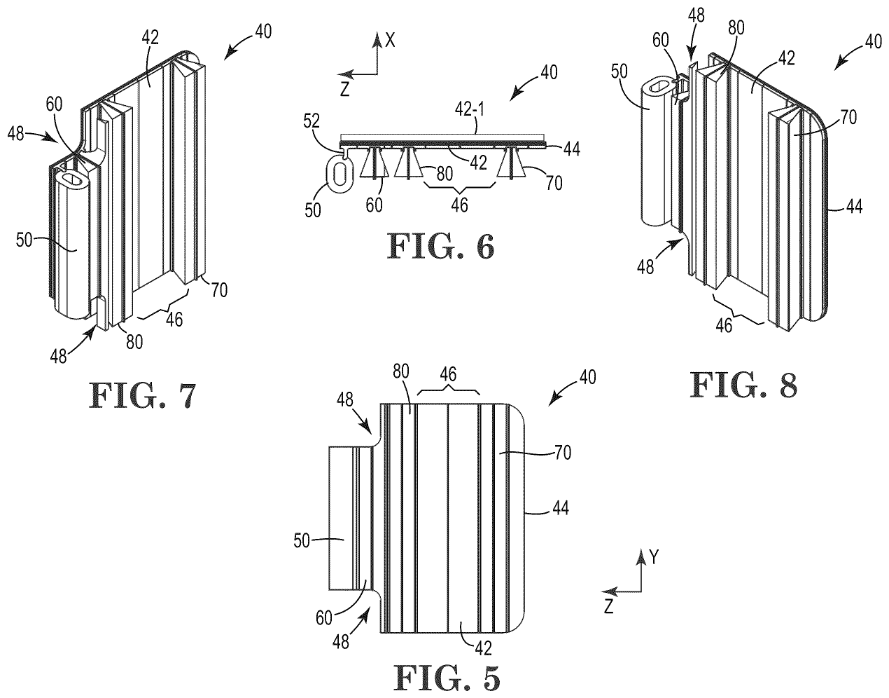

With reference to the depicted illustrative embodiment of dust plug 40, a drain channel 46 (see, e.g., FIGS. 5-8) may be broadly described as being located between the support member 50 and the interior weatherstrip member 70. In one or more embodiments, the drain channel can be described as being located between the exterior weatherstrip member 60 and the interior weatherstrip member 70.

In embodiments including an intermediate weatherstrip member 80, a drain channel 46 may be located between the interior weatherstrip member 70 and the intermediate weatherstrip member 80. It should be understood that, in embodiments including an intermediate weatherstrip member 80, a drain channel may also be formed between the exterior weatherstrip member 60 and the intermediate weatherstrip member 80.

Further, one or more alternative embodiments of dust plugs used in fenestration unit sealing systems as described herein may include more than one intermediate weatherstrip members. In such embodiments, still more drain channels may be located between adjacent pairs of intermediate weatherstrip members.

In one or more embodiments, when measured along an interior-exterior axis extending between the interior side and the exterior side of the side jamb 14 (e.g., the fenestration unit frame), the distance between the intermediate weatherstrip member 80 and the exterior face 20-2 of the panel 20 is less than the distance between interior weatherstrip member 70 and the interior face 20-1 of the panel 20. Shifting the drain channel defined by the interior weatherstrip member 70 towards the exterior face 20-2 of panel 20 may assist in capturing water moving down the edge 24 of panel 20 proximate the exterior side 20-2 of the panel 20 before that water reaches the bottom edge of the panel 20.

With reference to FIGS. 5-8, a variety of views of the illustrative embodiment of dust plug 40 depicted in FIGS. 3-4 are provided with the dust plug 40 removed from the fenestration unit. As discussed herein, the dust plug 40 includes a base 42 having a leading edge 44. A support member 50 is attached to the base 42 along with an exterior weatherstrip member 60, interior weatherstrip member 70, and optional intermediate weatherstrip member 80.

Although not required, each of the support member 50, exterior weatherstrip member 60, interior weatherstrip member 70, and optional intermediate weatherstrip member 80, when in position on a side jamb of one or more embodiments of a fenestration unit as described herein, may be described as being aligned with the Y-axis of the Cartesian coordinate systems depicted in the figures with that Y axis aligning with a jamb axis extending along the length of the side jamb on which the dust plug 40 is located.

Also depicted in FIGS. 5-8 is a drain channel 46 located between the interior weatherstrip member 70 and the optional intermediate weatherstrip member 80. Channel 46 may be useful, as described herein, in funneling water that infiltrates the seal provided by the side member weatherstrip 32 the top of the sill 15 before that water reaches the interior of the panel 20 at least over the distance occupied by the dust plug 40. Although exterior weatherstrip member 60 also forms a channel with interior weatherstrip member 70, one potential advantage of intermediate weatherstrip member 80 is that it extends to a location proximate the top of the sill above which dust plug 40 is positioned.

Another optional feature depicted in FIGS. 5, 7, and 8 are notches 48 which reduce the height or length of both the support member 50 and the exterior weatherstrip member 60. The notches 48 are sized to provide clearance for a portion of a sill above which the dust plug 40 is located to allow for the interior weatherstrip member 70 and optional intermediate weatherstrip member 80 to extend to a lower portion of the sill to assist with the water funneling functions provided by those features of the dust plug's described herein. The dust plug 40 includes a pair of notches 48 to allow for its use on both the right and left sides of fenestration units as described herein.

The support member 50 may take any suitable form that provides resilient support for the cantilevered leg 30-1 of the side member weatherstrip member 30. In the depicted illustrative embodiment, the support member 50 is in the form of a hollow tube constructed of a resilient elastomeric material, with the tube being attached to the base 42 of the dust plug 40 by a strut 52 (see, e.g., FIG. 6). In one or more alternative embodiments, the support member may or may not be hollow and could be constructed of any suitable resilient material, e.g., foams, elastomers, compressible bladders, plastic support legs, living hinges, fin/pile weatherstrip), etc.

Each of the exterior weatherstrip member 60, interior weatherstrip member 70, and optional intermediate weatherstrip member 80 are depicted as being constructed of pile material having a fin integrated into the pile. It should, however, be understood that in one or more alternative embodiments, one or more of the weatherstrip members may be provided with any suitable construction, e.g., compressible bulbs, leaf seals, pile without fins, foams, elastomeric seals, etc.

As depicted in FIG. 6, dust plug 40 includes adhesive 42-1 (e.g., pressure sensitive adhesive, etc.) provided on the base 42 of the dust plug 40 with the adhesive being used to attach the base 42 to a side jamb. In one or more alternative embodiments, dust plugs may be attached using any suitable technique or combination of techniques, including, but not limited to: mechanical fasteners (e.g., threaded fasteners, nails, brads, staples, rivets, barbs, snap fits, “Christmas trees”, T slots, etc.), thermal or chemical welding, etc. One potential advantage of using adhesives to attach the dust plugs to jambs is that the adhesive may form a barrier to limit or prevent water from passing between the base 42 of the dust plug 40 and the jamb to which the dust plug is attached.

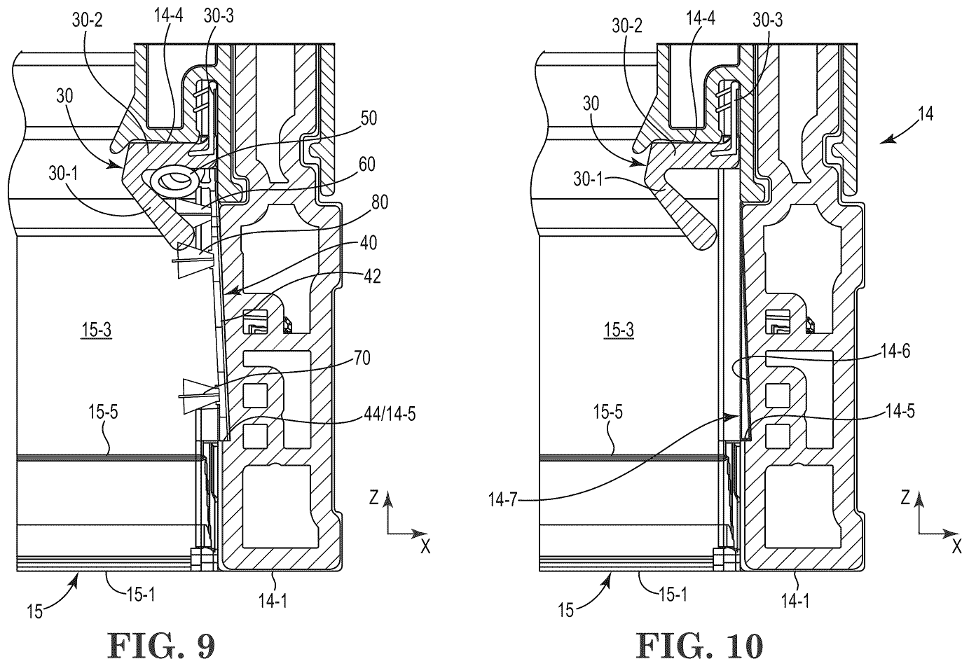

Another optional feature of one or more embodiments of sealing systems for fenestration units as described herein is depicted in FIGS. 9-10. The optional feature is in the form of a cavity 14-7 provided in the surface of jamb 14 facing the edge of a panel in a closed configuration within a fenestration unit as described herein. With reference to FIG. 10 in which the dust plug 40 is removed from the jamb 14, the depicted illustrative embodiment of a cavity 14-7 in jamb 14 includes a step 14-5 at its interior boundary and recessed inner surface 14-6.

With reference to FIG. 9 in which the dust plug 40 is positioned in the cavity 14-7 defined by the step 14-5 and recessed inner surface 14-6, the base 42 of dust plug 40 can be described as having an interior edge 44 facing away from the side member weatherstrip 30. That interior edge 44 of the base 42 is recessed within the cavity 14-7 such that the interior edge 44 is obscured within the cavity 14-7 by the first side jamb when the dust plug 40 is viewed along an interior-exterior axis extending between the interior side 14-1 and the exterior side 14-2 of a side jamb 14 of a fenestration unit frame as described herein. In the depicted illustrative embodiment, the interior-exterior axis is aligned with the Z axis of the Cartesian coordinate system depicted in the figures.

In one or more embodiments, the cavity 14-7 may have a cavity depth measured in a direction transverse to the interior-exterior axis that decreases when moving along the base 42 of the dust plug 40 from the interior edge 44 towards the side member weatherstrip 30 or door stop 14-4. In the depicted illustrative embodiment, the cavity depth is measured along the X axis of the Cartesian coordinate system depicted in the figures.

In one or more alternative embodiments of the sealing systems described herein, the dust plugs described herein may be positioned in cavities that do not decrease in depth as depicted in, e.g., FIG. 9. For example, the dust plugs may be positioned in cavities that have a uniform depth, cavities that have an increasing depth when moving from the interior side towards the exterior side of a jamb, cavities that have a variable depth when moving from the interior side towards the exterior side of a jamb, etc.

Regardless of whether the cavity 14-7 has a depth that decreases (as depicted in, e.g., FIG. 9), a uniform depth, an increasing depth, or a depth with any other suitable profile as described herein, the depth of the cavity 14-7 at the interior boundary 14-5 is sufficient to receive the interior edge 44 of the base 42 of the dust plug 40 such that the interior edge 44 does not protrude from the surface of the jamb 14 at the junction between the interior boundary 14-5 and leading edge 44.

Providing a dust plug 40 with a recessed leading edge 44 limits or prevents contact between the leading edge 44 of the base 42 of the dust plug 40 by panel 20 (or other article) moving along the surface of the jamb 14 in the direction of the interior-exterior axis. In particular, movement of a panel 20 from an open configuration to a closed configuration requires movement of the edge of the panel 20 over or along the surface of the jamb 14 as the panel moves towards weatherstrip 30 and door stop 14-4. In those embodiments in which the leading edge of a dust plug protrudes from the surface of the jamb 14, the leading edge of such a dust plug may be prone to damage by the panel 20.

The cavities in one or more embodiments of the sealing systems of fenestration units as described herein may be formed in the side jamb by any suitable technique or combination of techniques. As depicted in FIGS. 9-10, the cavity 14-7 me be formed by a router, but other possible techniques may include (depending on the material used to manufacture the side jamb) machining, milling, stamping, molding, etc. Although cavity 14-7 has a limited height (as measured along the side jamb/Y axis) defined by an upper edge distal from the sill 15, in one or more embodiments, the cavity in which the leading edge of a dust plug is located for protection may extend along the length of the side jamb. Such a construction may be, e.g., particularly useful for side jambs formed through, e.g., extrusion, pultrusion, milling, and other similar processes.

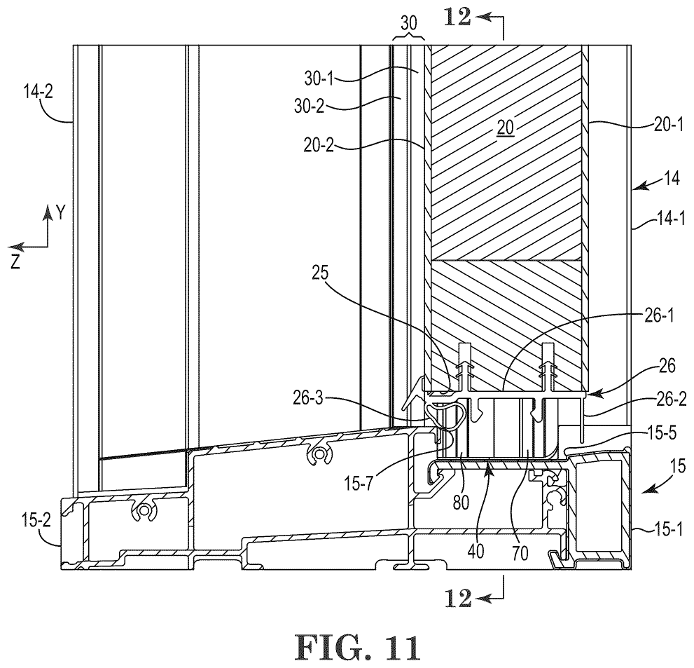

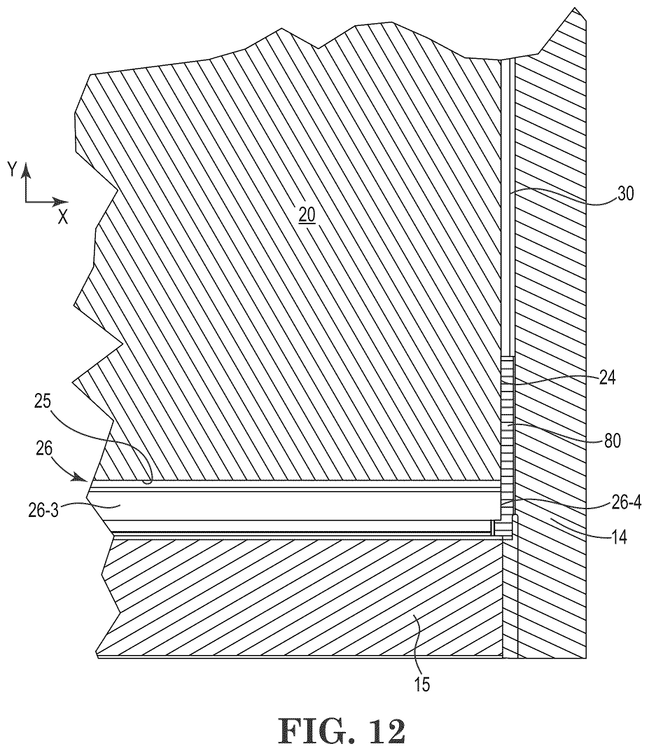

FIGS. 11 and 12 depict interactions of one illustrative embodiment of a dust plug of one illustrative embodiment of a sealing system of one illustrative embodiment of a panel including a sill sweep in one illustrative embodiment of a fenestration unit as described herein. FIG. 11 is an enlarged cross-sectional view of the junction between the sill, side jamb, door panel, sweep, side member weatherstrip, and dust plug of one illustrative embodiment of the sealing system for a fenestration unit as described herein taken along line 11-11 in FIG. 1. FIG. 12 is a cross-sectional view of the junction depicted in FIG. 11 taken along line 12-12 in FIG. 11.

With reference to FIG. 11, the bottom edge 25 of panel 20 includes one illustrative embodiment of a sweep 26 may be used to seal the panel-sill gap between the bottom edge 25 of panel 20 and the sill 15 when panel 20 is in its closed configuration in one or more embodiments of a fenestration unit as described herein.

In the depicted illustrative embodiment, the sweep 26 includes a base 26-1 attached to the bottom edge 25 of panel 20 and an interior fin 26-2 located along the interior side of base 26-1. Sweep 26 also includes an exterior bulb 26-3 configured to form a seal with a feature 15-7 on sill 15 proximate the exterior face 20-2 of panel 20 when panel 20 is in its closed configuration as depicted in FIG. 11.

Sweep 26 is only one example of many different sweep constructions that may be used to provide a seal along the panel-sill gap of a fenestration unit as described herein and sweeps with many other configurations are possible. Regardless of the specific construction of a sweep 26 located on the bottom edge 25 of a panel of a fenestration unit as described herein, the sweep 26 will terminate proximate the latch edge 24 of panel 20. As a result, a sweep-jamb gap will typically be formed between the latch side end 26-4 of the sweep 26 and the jamb 14 in addition to the panel-sill gap located between the bottom edge 25 of panel 20 and the sill 15.

The dust plugs provided in one or more embodiments of the sealing systems described herein can be used to assist in sealing that sweep-jamb gap. In particular, the exterior weatherstrip member 60 and/or the intermediate weatherstrip member 80 may occupy at least a portion and possibly all of the sweep-jamb gap. In one or more embodiments one or both of the exterior weatherstrip member 60 and intermediate weatherstrip member 80 may contact the latch side end 26-4 of the sweep 26 to provide additional resistance to infiltration of water and or air at the junction between the latch edge 24 and bottom edge 25 of panel 20 when in the closed position.

With reference to FIG. 12 which depicts the panel-sill gap as well as FIGS. 3, 5, 7, and 8 which depict the illustrative embodiment of dust plug 40, in one or more embodiments of the dust plugs as described herein, the support member 50 may have a support member height measured along the Y axis (corresponding to the length of a side jamb of a fenestration unit as described herein) that is greater than the panel-sill gap along that same axis.

Similarly, the exterior weatherstrip member 60 in one or more embodiments of the dust plugs described herein may have an exterior weatherstrip member height measured along the Y axis that is greater than the panel-sill gap along that same axis.

Further, the interior weatherstrip member 70 in one or more embodiments of dust plugs described herein may have an interior weatherstrip member height measured along the Y axis that is also greater than the panel-sill gap along the same axis.

Still further, the optional intermediate weatherstrip member 80 in one or more embodiments of dust plugs described herein may have an intermediate weatherstrip member height measured along the Y axis that is also greater than the panel-sill gap along the same axis.

In one or more embodiments of dust plugs described herein including both an interior weatherstrip member 70 and an intermediate weatherstrip member 80, the intermediate weatherstrip member height may be equal to the interior weatherstrip member height such that a drain channel defined in the dust plug 40 by the interior weatherstrip member 70 and the intermediate weatherstrip member 80 as a uniform height when moving along the interior-exterior axis (i.e., along the Z-axis in the Cartesian coordinate systems depicted in the figures).

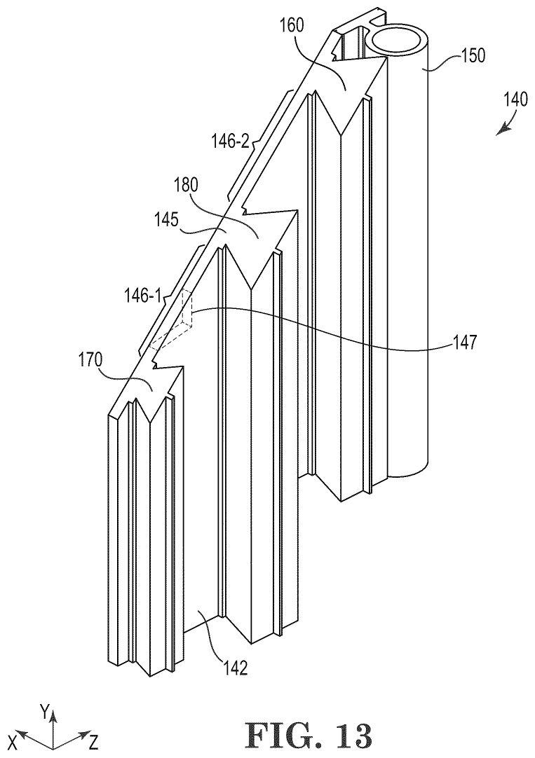

FIG. 13 depicts one alternative embodiment of a dust plug that could be used in one or more embodiments of the sealing systems described herein. Unlike the illustrative embodiment of dust plug 40 described herein, dust plug 140 has a sloping or angled upper edge 145 to provide a lower profile proximate the interior edge of a fenestration unit.

The illustrative embodiment of dust plug 140 includes a support member 150, exterior weatherstrip member 160, interior weatherstrip member 170, and optional intermediate weatherstrip member 180 attached to a base 142. In the depicted embodiment, each of these components is, when installed on a side jamb of a fenestration unit as described herein, generally aligned with a side jamb axis which aligns with the Y-axis as depicted in the Cartesian coordinate system of FIG. 13.

Dust plug 140 also includes a drain channel 146-1 defined between the interior weatherstrip member 170 and optional intermediate weatherstrip member 180 as well as an additional drain channel 146-2 located between the interior weatherstrip member 160 and the intermediate weatherstrip member 180.

Another feature depicted in connection with the illustrative embodiment of dust plug 140 is the thickness of the interior weatherstrip member 170 relative to the thickness of the exterior weatherstrip member 160 and the intermediate weatherstrip member 180. As depicted, the thickness of the interior weatherstrip member 170, where thickness is measured along the X-axis direction, is less than the thickness of the exterior weatherstrip member 160 as well as the intermediate weatherstrip member 180. These differences are provided in connection with illustrative dust plug 140 to show that the thickness of the various weatherstrip features need not be the same (as depicted in connection with, e.g., the dust plug 40 of FIG. 6. In one or more embodiments, having a thinner/shorter interior weatherstrip member may result in less wear on the interior weatherstrip member 170 during use which could, in turn, lead to improvements in service life of the dust plugs.

Although not depicted, in one or more embodiments, the upper edge 145 of the base 142 of dust plug 140 may include a notch or other discontinuity 147 (depicted in broken lines) between the interior weatherstrip member 170 and the optional intermediate weatherstrip member 180 (where provided) or between the interior weatherstrip member 170 and the exterior weatherstrip member 160 in embodiments in which the intermediate weatherstrip member 180 is not provided. The notch or discontinuity 147 may limit the flow of water along the upper edge 145 of the base 142 and, instead, direct that water into the drain channel 146 and towards a sill above which dust plug 140 is located. In one or more embodiments, the angled upper edge 145 may be described as forming an angle greater than 90° with the leading edge 144 of the base 142 of dust plug 140.

Other relationships between the features of dust plug 140 with an angled or sloping upper edge 145 include height differences measured along the side jamb/Y axis. In particular, the support member 150 may be described as having a support member height along the side jamb/Y axis that is greater than the height of exterior weatherstrip member 160 and/or the interior weatherstrip member 170. In embodiments including the optional intermediate weatherstrip member 180, the support member height may also be greater than the height of the intermediate weatherstrip member 180. Further, the exterior weatherstrip member 160 may be described as having an exterior weatherstrip member height greater than the height of the interior weatherstrip member 170. When provided, the intermediate weatherstrip member 180 may be described as having an intermediate weatherstrip member height greater than the height of the interior weatherstrip member 170.

The various components used in the sealing systems and fenestration units described herein may be constructed of any suitable material or combination of materials including polymers, metals, composites, wood, ceramics, etc. The particular materials used need only perform the functions of the various components as described herein and suitable choices for the materials will be known to those of skill in the art.

The complete disclosure of the patents, patent documents, and publications identified herein are incorporated by reference in their entirety as if each were individually incorporated. To the extent there is a conflict or discrepancy between this document and the disclosure in any such incorporated document, this document will control.

Illustrative embodiments of sealing systems, dust plugs, and fenestration units incorporating them, and related methods are discussed herein with some possible variations described. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof. It should also be understood that this invention also may be suitably practiced in the absence of any element not specifically disclosed as necessary herein.

1. A sealing system for a fenestration unit, the sealing system comprising:
a fenestration frame comprising a side frame member connected to a sill, wherein the sill and the side frame member comprise an interior side and an exterior side, and wherein the side frame member extends along a side frame member axis extending away from the sill;
a panel retained in the fenestration frame, the panel positioned above the sill, the panel comprising an interior face, an exterior face, a first edge, a second edge, a top edge, and a bottom edge, wherein, when the panel is in a closed configuration in the fenestration frame, the first edge faces the side frame member and the bottom edge faces the sill;
a side frame member weatherstrip attached to the side frame member, wherein, when the panel is in a closed configuration in the fenestration frame, the first edge of the panel faces the side frame member, the bottom edge of the panel faces the sill, and the exterior face of the panel contacts the side frame member weatherstrip, wherein the side frame member weatherstrip comprises a cantilevered leg that, when the exterior face of the panel is not in contact with the side frame member weatherstrip, defines a channel aligned with the side frame member axis, the first channel located between the side frame member and the cantilevered leg, and wherein, when the panel is in the closed configuration, the exterior face of the panel displaces the cantilevered leg towards the side frame member to reduce a size of the channel; and
a dust plug comprising:
a base attached to the side frame member proximate the sill,
a support member attached to the base, the support member located in the channel between the side frame member and the cantilevered leg proximate the sill,
an exterior weatherstrip member attached to the base, wherein a portion of the exterior weatherstrip member is located in a panel-sill gap measured along the side frame member axis between the bottom edge of the panel and a top of the sill at a junction between the bottom edge, the exterior face, and the first edge of the panel when the panel is in the closed configuration, and
an interior weatherstrip member attached to the base, the interior weatherstrip member located proximate an interior edge of the base such that the exterior weatherstrip member is located between the support member and the interior weatherstrip member, and wherein the interior weatherstrip member contacts the first edge of the panel when the panel is in the closed configuration.

2. A sealing system according to claim 1, wherein the exterior weatherstrip member is located in the channel between the support member and the cantilevered leg when the exterior face of the panel is not in the closed configuration such that the panel is not in contact with the cantilevered leg of the side frame member weatherstrip.

3. A sealing system according to claim 1, wherein the sealing system comprises a sweep attached to the bottom edge of the panel such that, when the panel is in the closed configuration, the sweep is located in the panel-sill gap, wherein the sweep extends between a first end proximate the first edge of the panel and a second end proximate the second edge of the panel, and wherein the portion of the exterior weatherstrip member located in the panel-sill gap contacts the first end of the sweep when the panel is in the closed configuration.

4. A sealing system according to claim 1, wherein the exterior weatherstrip member is aligned with the side frame member axis.

5. A sealing system according to claim 1, wherein the interior weatherstrip member is aligned with the side frame member axis.

6. A sealing system according to claim 1, wherein the support member comprises a support member height measured along the side frame member axis, and wherein the support member height is greater than the panel-sill gap.

7. A sealing system according to claim 1, wherein the dust plug comprises a drain channel aligned with the side frame member axis, the drain channel located between the support member and the interior weatherstrip member such that drain channel is located between the first edge of the panel and the side frame member when the panel is in the closed configuration.

8. A sealing system according to claim 7, wherein the drain channel is located between the exterior weatherstrip member and the interior weatherstrip member.

9. A sealing system according to claim 1, wherein the exterior weatherstrip member comprises an exterior weatherstrip member height measured along the side frame member axis, and wherein the exterior weatherstrip member height is greater than the panel-sill gap.

10. A sealing system according to claim 9, wherein the support member height is equal to the exterior weatherstrip member height.

11. A sealing system according to claim 1, wherein the interior weatherstrip member comprises an interior weatherstrip member height measured along the side frame member axis, and wherein the interior weatherstrip member height is greater than the panel-sill gap.

12. A sealing system according to claim 1, wherein the base comprises an interior edge facing away from the side frame member weatherstrip and the side frame member comprises a cavity, wherein the interior edge of the base is recessed within the cavity such that the interior edge is obscured by the side frame member when viewed along an interior-exterior axis extending between the interior side and the exterior side of the side frame member.

13. A sealing system according to claim 12, wherein the cavity comprises a cavity depth measured in a direction transverse to the interior-exterior axis, and wherein the cavity depth decreases when moving along the base from the interior edge towards the side frame member weatherstrip.

14. A sealing system according to claim 1, wherein the base of the dust plug is adhesively attached to the side frame member.

15. A sealing system according to claim 1, wherein the dust plug comprises an intermediate weatherstrip member attached to the base, the intermediate weatherstrip member located between the exterior weatherstrip member and the interior weatherstrip member, and wherein the intermediate weatherstrip member contacts the first edge of the panel when the panel is in the closed configuration.

16. A sealing system according to claim 15, wherein the intermediate weatherstrip member is aligned with the side frame member axis.

17. A sealing system according to claim 15, wherein the intermediate weatherstrip member comprises an intermediate weatherstrip member height measured along the side frame member axis, and wherein the intermediate weatherstrip member height is greater than the panel-sill gap.

18. A sealing system according to claim 17, wherein the intermediate weatherstrip member height is equal to or greater than the interior weatherstrip member height.

19. A sealing system according to claim 15, wherein dust plug comprises a drain channel aligned with the side frame member axis, the drain channel located between the intermediate weatherstrip member and the interior weatherstrip member such that drain channel is located between the first edge of the panel and the side frame member when the panel is in the closed configuration.

20. A sealing system according to claim 15, wherein, as measured along an interior-exterior axis extending between the interior side and the exterior side of the side frame member, a first distance between the intermediate weatherstrip member and the exterior face of the panel is less than a second distance between interior weatherstrip member and the interior face of the panel.

21. A sealing system for a fenestration unit, the sealing system comprising:
a fenestration frame comprising a side frame member connected to a sill, wherein the sill and the side frame member comprise an interior side and an exterior side, and wherein the side frame member extends along a side frame member axis extending away from the sill;
a panel retained in the fenestration frame, the panel positioned above the sill, the panel comprising an interior face, an exterior face, a first edge, a second edge, a top edge, and a bottom edge, wherein, when the panel is in a closed configuration in the fenestration frame, the first edge faces the side frame member and the bottom edge faces the sill;
a side frame member weatherstrip attached to the side frame member, wherein, when the panel is in a closed configuration in the fenestration frame, the first edge of the panel faces the side frame member, the bottom edge of the panel faces the sill, and the exterior face of the panel contacts the side frame member weatherstrip, wherein the side frame member weatherstrip comprises a cantilevered leg that, when the exterior face of the panel is not in contact with the side frame member weatherstrip, defines a channel aligned with the side frame member axis, the first channel located between the side frame member and the cantilevered leg, and wherein, when the panel is in the closed configuration, the exterior face of the panel displaces the cantilevered leg towards the side frame member to reduce a size of the channel; and
a dust plug comprising:
a base attached to the side frame member proximate the sill,
a support member attached to the base, the support member located in the channel between the side frame member and the cantilevered leg proximate the sill,
an exterior weatherstrip member attached to the base, wherein a portion of the exterior weatherstrip member is located in a panel-sill gap measured along the side frame member axis between the bottom edge of the panel and a top of the sill at a junction between the bottom edge, the exterior face, and the first edge of the panel when the panel is in the closed configuration, and
an interior weatherstrip member attached to the base, the interior weatherstrip member located proximate an interior edge of the base such that the exterior weatherstrip member is located between the support member and the interior weatherstrip member, and wherein the interior weatherstrip member contacts the first edge of the panel when the panel is in the closed configuration;
wherein the exterior weatherstrip member is located in the channel between the support member and the cantilevered leg when the exterior face of the panel is not in the closed configuration such that the panel is not in contact with the cantilevered leg of the side frame member weatherstrip;
wherein the support member comprises a support member height measured along the side frame member axis, and wherein the support member height is greater than the panel-sill gap;
wherein the dust plug comprises a drain channel aligned with the side frame member axis, the drain channel located between the support member and the interior weatherstrip member such that drain channel is located between the first edge of the panel and the side frame member when the panel is in the closed configuration;
and wherein the base comprises an interior edge facing away from the side frame member weatherstrip and the side frame member comprises a cavity, wherein the interior edge of the base is recessed within the cavity such that the interior edge is obscured by the side frame member when viewed along an interior-exterior axis extending between the interior side and the exterior side of the side frame member.

22. A sealing system according to claim 21, wherein the dust plug comprises an intermediate weatherstrip member attached to the base, the intermediate weatherstrip member located between the exterior weatherstrip member and the interior weatherstrip member, and wherein the intermediate weatherstrip member contacts the first edge of the panel when the panel is in the closed configuration.

23. A method of sealing an interface between a panel and a side frame member of a fenestration unit, the method comprising;
positioning a dust plug on a side frame member of a fenestration panel, wherein the dust plug comprises:
a base attached to the side frame member proximate a sill of the fenestration unit,
a support member attached to the base, and
an exterior weatherstrip member attached to the base, wherein a portion of the exterior weatherstrip member is located in a panel-sill gap measured along the side frame member axis between a bottom edge of the panel and a top of a sill of the fenestration unit at a junction between a bottom edge of the panel, an exterior face of the panel, and a first edge of the panel when the panel is in a closed configuration in which the first edge of the panel displaces the cantilevered leg of the side frame weatherstrip member towards the side frame member, and
an interior weatherstrip member attached to the base, the interior weatherstrip member located proximate an interior edge of the base such that the exterior weatherstrip member is located between the support member and the interior weatherstrip member, and wherein the interior weatherstrip member contacts the first edge of the panel when the panel is in the closed configuration;
wherein positioning the dust plug on the side frame member comprises locating the support member of the dust plug between the side frame member and a cantilevered leg of a side frame weatherstrip member attached to the side frame member, wherein the support member forces the cantilevered leg away from the side frame member proximate the sill when the panel is not in the closed configuration.

24. A method according to claim 23, wherein the dust plug directs water passing along the side frame member towards the sill through a drain channel aligned with a side frame member axis of the side frame member when the panel is in the closed configuration, the drain channel located between the interior weatherstrip member and the support member.

25. A method according to claim 23, wherein the dust plug comprises an intermediate weatherstrip member attached to the base, the intermediate weatherstrip member located between the exterior weatherstrip member and the interior weatherstrip member, and wherein the intermediate weatherstrip member contacts the first edge of the panel when the panel is in the closed configuration.
